(19) United States
(12) Patent Application Publication
(10) Pub. No.: US 2025/0094917 A1
(43) Pub. Date: Mar. 20, 2025

(54) INFORMATION PROCESSING DEVICE

(71) Applicant: TOYOTA JIDOSHA KABUSHIKI KAISHA, Toyota-shi (JP)

(72) Inventors: Masahiro KAGAMI, Nagoya-shi (JP); Keisuke ISOMURA, Kariya-shi (JP); Tatsuhiko SASAKI, Toyota-shi (JP); Hirobumi ISOGAI, Toyota-shi (JP)

(73) Assignee: TOYOTA JIDOSHA KABUSHIKI KAISHA, Toyota-shi (JP)

(21) Appl. No.: 18/826,182

(22) Filed: Sep. 6, 2024

(30) Foreign Application Priority Data
Sep. 19, 2023 (JP) 2023-150851

(51) Int. Cl. G06Q 10/0833; G06Q 10/30

(52) U.S. Cl. CPC G06Q 10/0833; G06Q 10/30

(57) ABSTRACT

A control unit configured to execute: acquiring a past processing result of each of a plurality of companies constituting a supply chain that manufactures a product by a plurality of processes using a recycled material, a current load state, an inventory amount, and a required amount of recycled material; generating a combination of companies in which the load of each company corresponding to each process is equal to or less than a predetermined load in accordance with a past processing result, a current load state, an inventory amount, and a required amount of recycled material in a plurality of processes in response to generation of the recycled material; and outputting information on a delivery time and a delivery amount of the recycled material to terminals of each company corresponding to a combination of the generated companies.

### CROSS-REFERENCE TO RELATED APPLICATION

This application claims priority to Japanese Patent Application No. 2023-150851 filed on Sep. 19, 2023, incorporated herein by reference in its entirety.

### BACKGROUND

### 1. Technical Field

The present disclosure relates to an information processing device.

### 2. Description of Related Art

Japanese Unexamined Patent Application Publication No. 2002-288312 (JP 2002-288312 A) discloses that a collector inputs collected product information using a communication unit and notifies a recycling factory or a recycling center that collects a specific part to be collected in a collected product of delivery information on a collected product based on the collected product information. Japanese Unexamined Patent Application Publication No. 2002-273399 (JP 2002-273399 A) discloses that a collector that collects a product sold to a user inputs collected product information using a communication unit, a specific part to be collected in the collected product is collected at a recycling factory or a recycling center based on the collected product information, and the user, a sales company, a dealer, etc. are notified of the progress of collection of the product. Japanese Unexamined Patent Application Publication No. 2002-166258 (JP 2002-166258 A) discloses that a merchant grasps distribution information including at least one of purchase information, shipping information, inventory information, and summary and processing information on used products or processed products of used products possessed by different merchants other than at least business partners on the directly upstream side and the directly downstream side, and adjusts at least one of the purchase amount, the shipping amount, and the inventory amount of the merchant itself based on the distribution information.

### SUMMARY

An object of the present disclosure is to appropriately allocate a recycled material to companies involved in processes of recycling.

One aspect of the present disclosure provides an information processing device including a control unit configured to: acquire respective past processing performances of a plurality of companies that constitutes a supply chain that manufactures a product through a plurality of processes using a recycled material, a current load state, an inventory amount, and an amount of the recycled material required; in response to generation of the recycled material, generate a combination of companies corresponding to respective ones of the processes, loads on the companies corresponding to the respective processes being equal to or less than respective predetermined loads, according to the past processing performance, the current load state, the inventory amount, and the amount of the recycled material required; and output information about a delivery time and a delivery amount of the recycled material to respective terminals of the companies corresponding to the generated combination of companies.

Other aspects of the present disclosure provide an information processing method that causes a computer to execute the above information processing, a program that causes a computer to execute the information processing method, and a computer-readable storage medium that stores the program in a non-transitory manner.

According to the present disclosure, it is possible to appropriately allocate a recycled material to companies involved in processes of recycling.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a supply chain according to an embodiment;

FIG. 2 is a block diagram schematically illustrating an example of a configuration of each of a company terminal and a server constituting the system according to the embodiment;

FIG. 3 is a diagram illustrating a table configuration of a company information DB;

FIG. 4 is a flow chart showing a process executed in the server according to the first embodiment; and

FIG. 5 is a flowchart illustrating a process executed in the server according to the second embodiment.

### DETAILED DESCRIPTION OF EMBODIMENTS

Several companies may be involved in recycling goods. For example, after an article is discarded, recycling is performed through a plurality of processes, but since lead time and yield exist in each process, it may be difficult for a company in a post-process to predict when and how much recycled material is delivered. In addition, if a large number of recycled materials are delivered to one company at a time, there is a possibility that the processing will not be completed in time and the post-processing will also be affected. Therefore, it is difficult for each company to make a production plan for a product. On the other hand, if the amount of recycled material delivered to each company and the delivery time are leveled and the amount and time of recycled material delivered can be notified to each company in advance, it is easy for each company to prepare a production plan.

Therefore, the control unit included in the information processing device according to one aspect of the present disclosure acquires the past processing results of each of the plurality of companies constituting the supply chain that manufactures the product by a plurality of processes using the recycled material. Further, the control unit included in the information processing device acquires the current load state. The control unit included in the information processing device acquires an inventory amount and a required amount of the recycled material. The supply chain is a series of processes for producing new products using recycled materials. The supply chain may be, for example, a supply chain in which a battery mounted on a vehicle is recycled to manufacture a new battery. There is not only one company corresponding to each process. In the following description, the articles delivered to each company are referred to as recycled materials, and the articles generated by each company are referred to as products. Therefore, each enterprise delivers recycled materials from the enterprises in the previous process, generates products from the recycled materials, and delivers the products to the enterprises in the subsequent process. In this way, the article is recycled by a plurality of steps.

The past processing results may include information on the time when the product is generated using the recycled material and the generated amount. In addition, the past processing results may include a yield, a lead time, and the like. The current load status, inventory, and recycled material requirements of a company are information about the amount of recycled material that should be delivered to the company at this time. The current load condition may be, for example, a ratio of the current throughput to the maximum possible throughput. The current inventory is the amount of recycled materials owned by each company. The amount of recycled material may be expressed in terms of mass or volume. The amount of recycled material required at present is the amount of recycled material required for the production of the product in each company. For example, in a case where an article is produced by mixing a recycled material and a new material at a predetermined ratio in a certain enterprise, a required amount of the recycled material is calculated from the amount of the product to be produced in the enterprise. For example, the control unit acquires the past processing results, the current load status, the inventory amount, and the required amount of the recycled material from the terminals of the respective companies.

Further, in response to the generation of the recycled material, the control unit generates a combination of the companies corresponding to each of the processes in the plurality of processes in accordance with the past processing results, the current load state, the inventory amount, and the required amount of the recycled material, and the load of the company corresponding to each of the processes becomes equal to or less than a predetermined load. The predetermined load is determined so that the load does not become excessive in each company. This predetermined load may be input from a terminal of each company or may be input by an operator managing the supply chain. When the recycled material is generated, the control unit generates a combination of companies corresponding to each process such that the load of each company is equal to or less than a predetermined load. Statistical methods such as regression analysis or machine learning models can be used to generate this combination. By allocating recycled materials in accordance with the generated combinations, it is possible to suppress an excessive increase in the burden at each enterprise and to equalize the processing.

Then, the control unit outputs information on the delivery time and the delivery amount of the recycled material to the terminals of the respective companies corresponding to the generated combination of the companies. Information regarding the delivery time and the delivery amount of the recycled material corresponding to each company may be generated using a statistical method such as regression analysis or a machine learning model. In addition, the control unit may generate information on the delivery time and the delivery amount of the recycled material together with the combination of the above-described companies. The information output by the control unit may include a command for displaying the delivery time and the delivery amount of the recycled material on the display of the terminal of each company. In this way, the delivery time and the delivery amount can be notified in advance to each company to which the recycled material is delivered, so that the production plan of the product can be easily prepared in each company.

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### First Embodiment

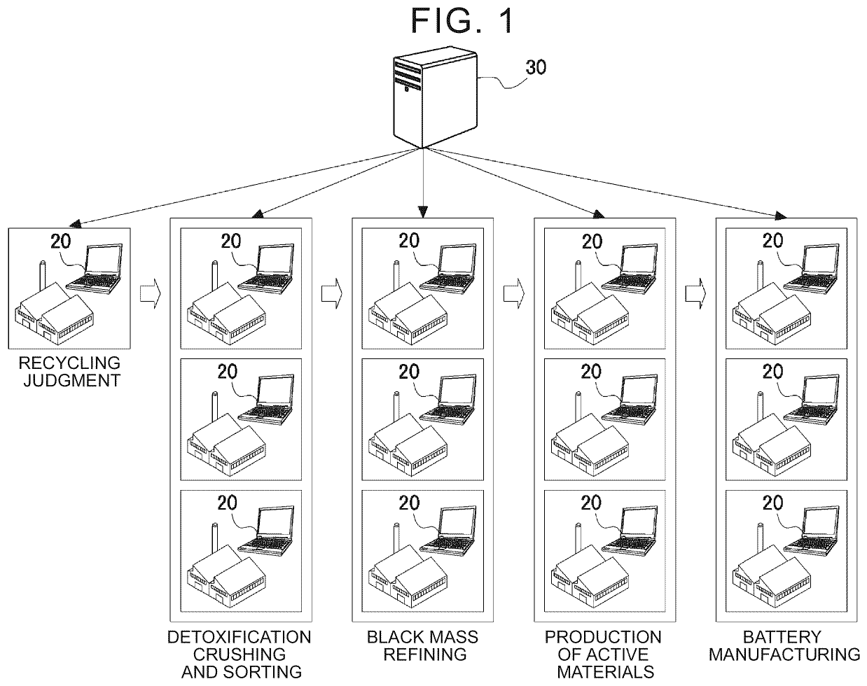

FIG. 1 is a diagram illustrating an example of a supply chain according to the present embodiment. In the example of FIG. 1, a scene in which a new battery is manufactured by recycling a battery of an automobile is assumed. Companies corresponding to the supply chain shown in FIG. 1 include a company that makes a recycling determination, a company that performs detoxification crushing and sorting, a company that refines black mass, a company that produces active materials, and a company that manufactures batteries.

A company that makes a recycling determination is a company that corresponds to a process of determining whether or not a battery is to be recycled. For example, in a case where the degree of deterioration of the performance of the battery is low, the battery may not be recycled but may be mounted on another vehicle as it is, or the battery may be disassembled and used for another application. Therefore, the company that makes the recycling determination determines whether or not the battery is crushed and recycled. Companies that make recycling decisions deliver batteries that are determined to be recycled to companies that conduct detoxification, crushing, and sorting, which are companies in the post-process.

An enterprise that performs detoxification and crushing and sorting is an enterprise corresponding to a process in which, for example, a battery is subjected to heat treatment to detoxify, a battery is crushed, and a black mass is sorted. Companies engaged in detoxifying, crushing, and sorting supply black masses to companies that refine black masses, which are companies in the post-process.

A company that refines black mass is a company that handles the process of separating and purifying lithium, cobalt, nickel, and the like from black mass. Companies that refine black masses deliver refined materials, such as lithium, cobalt, and nickel, to companies that manufacture active materials, which are post-process companies.

An enterprise that manufactures active materials is an enterprise corresponding to a process of manufacturing active materials used in batteries from lithium or the like. A company that manufactures active materials delivers the active materials to a company that manufactures batteries, which is a company in a post-process.

An enterprise that manufactures batteries is an enterprise corresponding to a process of manufacturing a battery that can be mounted on an automobile from an active material. A company that manufactures a battery delivers the manufactured battery to a company that manufactures, for example, an automobile, which is a company in a later process.

There may be a plurality of enterprises that make a recycling judgment, an enterprise that performs detoxification and crushing and sorting, an enterprise that refines black mass, an enterprise that manufactures active materials, and an enterprise that manufactures batteries.

As illustrated in FIG. 1, the system according to an example of the present embodiment includes a server 30 and a plurality of company terminals 20. The server 30 acquires, from the terminal (the company terminal 20) corresponding to each enterprise, information regarding the processing result, the current load status, the inventory amount, the required amount of recycled material, and the location of the enterprise. Then, when the recycled material is generated, the server 30 determines a combination of companies corresponding to each process based on the information. The server 30 is an example of an information processing device.

The server 30 and the company terminals 20 are connected to each other via a network. The network may be, for example, a global public communication network such as the Internet WAN (Wide Area Network) or another communication network. The network may also include telephone communication networks for cellular phones and the like, and wireless communication networks such as Wi-Fi (registered trademark).

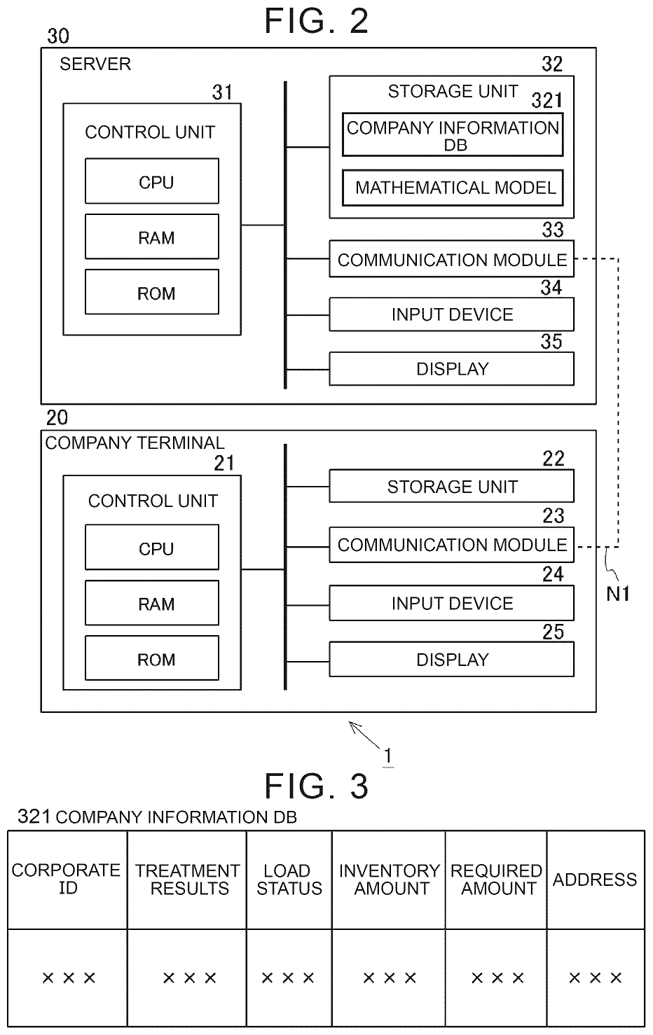

FIG. 2 is a block diagram schematically showing an example of the configuration of each of the company terminal 20 and the server 30 constituting the system 1 according to the present embodiment. The server 30 includes a control unit 31, a storage unit 32, a communication module 33, an input device 34, and a display 35.

The server 30 can be configured as a computer including a processor (such as a CPU, GPU), a main storage device (such as a RAM, ROM), and a secondary storage device (such as a EPROM, a hard disk drive, and a removable medium). The secondary storage device stores an operating system (OS), various programs, various tables, and the like. By executing the program stored in the auxiliary storage device, it is possible to realize each function (software module) that matches a predetermined purpose, as will be described later. However, some or all of the modules may be realized as hardware modules by, for example, hardware circuitry such as an ASIC, FPGA.

The control unit 31 is an arithmetic unit that realizes various functions of the server 30 by executing a predetermined program. The control unit 31 can be realized by, for example, a hardware processor such as a CPU. In addition, the control unit 31 may be configured to include Random Access Memory (RAM), Read Only Memory (ROM), a cache memory, and the like. Details of the control unit 31 will be described later.

The storage unit 32 is a unit that stores information, and is configured by a storage medium such as a RAM, a magnetic disk, or a flash memory. The storage unit 32 stores a program executed by the control unit 31, data used by the program, and the like. A database (company information DB321) is constructed in the storage unit 32, and information collected from the company terminals 20 is stored in the database. The storage unit 32 also stores an arithmetic model that outputs a combination of companies that process recycled materials.

FIG. 3 is a diagram illustrating a table configuration of the company information DB321. The company information DB321 stores information related to each of a process result, a load-state, an inventory amount, a required amount, and a location in association with the enterprise ID. The enterprise ID is an identity unique to the enterprise or company terminal 20. The processing result is a past processing result of the company, and includes, for example, information on yield and lead time. The load state is a current load state in the company, and may be, for example, a ratio of the current processing amount to the maximum possible processing amount in the company. The inventory amount is the current inventory amount of recycled material in the company. The required amount is the current amount of recycled material required by the enterprise, and is the amount of recycled material required for processing by the enterprise. The location is the location of the enterprise and the location where the recycled material is delivered. In the following, information related to ID of enterprises, and information related to each of the process performance, the load-state, the inventory quantity, the required quantity, and the location are collectively referred to as company information. The company information is information related to the amount of recycled material to be delivered to the enterprise at the present time. It should be noted that the company information may also include other parameters relating to the amount of recycled material to be delivered to the enterprise at the present time. The control unit 31 receives the enterprise information from the company terminal 20 at predetermined intervals and stores the enterprise information in the company information DB321.

The communication module 33 is a communication interface for connecting the server 30 to a network. The communication module 33 may be configured to include, for example, a network interface board, a wireless communication interface for wireless communication, and the like. The server 30 can perform data communication with the company terminal 20 via the communication module 33.

The input device 34 is a unit that receives an input operation performed by an operator. Specifically, the input device 34 is a device for inputting a mouse, a keyboard, or the like. The display 35 is a means for presenting information to an operator. The input device 34 and the display 35 may be integrally formed of, for example, a touch panel display.

Note that the specific hardware configuration of the server 30 can be omitted, replaced, or added as appropriate depending on the embodiment.

Next, the company terminal 20 includes a control unit 21, a storage unit 22, a communication module 23, an input device 24, and a display 25. The control unit 21 is an arithmetic unit that realizes various functions of the company terminal 20 by executing a predetermined program. The control unit 21 can be realized by, for example, a hardware processor such as a CPU. The control unit 21 may include a RAM, ROM, a cache memory, and the like.

The storage unit 22 is a means for storing information, and is composed of a storage medium such as a RAM, a magnetic disk, or a flash memory. The storage unit 22 stores a program executed by the control unit 21, data used by the program, and the like. Further, the storage unit 22 stores past processing results, current load status, current inventory amount, current recycled material required amount, and the location of the company.

The communication module 23, the input device 24, and the display 25 are the same as those of the communication module 33, the input device 34, and the display 35 of the server 30, and thus description thereof will be omitted.

The control unit 21 of the company terminal 20 acquires the company information from, for example, an operator via the input device 24 or from a manufacturing apparatus of the enterprise. Then, the control unit 21 of the company terminal 20 transmits the company information to the server 30 at predetermined time intervals.

Next, the control unit 31 of the server 30 will be described in detail. When a recycled material is generated, the control unit 31 of the server 30 determines a combination of companies that process the recycled material in each process based on the company information acquired from the company terminal 20. The control unit 31 determines a combination of enterprises using, for example, an arithmetic model. The calculation model is a model that outputs a combination of enterprises as output data by inputting information on generated recycled materials and company information as input data. Information on recycled materials includes information on the place of generation of recycled materials and the amount of generation of recycled materials. This model may be a machine learning model. The output combination of enterprises may include a plurality of enterprises corresponding to one process. As another example, a combination of enterprises may be output by using a statistical method such as regression analysis. The arithmetic model outputs a combination of enterprises such that the load of each enterprise is less than or equal to a predetermined load. As another example, the calculation model may output a combination of enterprises so that the load of each enterprise becomes uniform, for example.

Further, in the above calculation model, the amount of recycled material delivered to each company and the delivery time are also output. Then, the control unit 31 may notify the corresponding company terminal 20 of the amount of recycled material to be delivered and the delivery time.

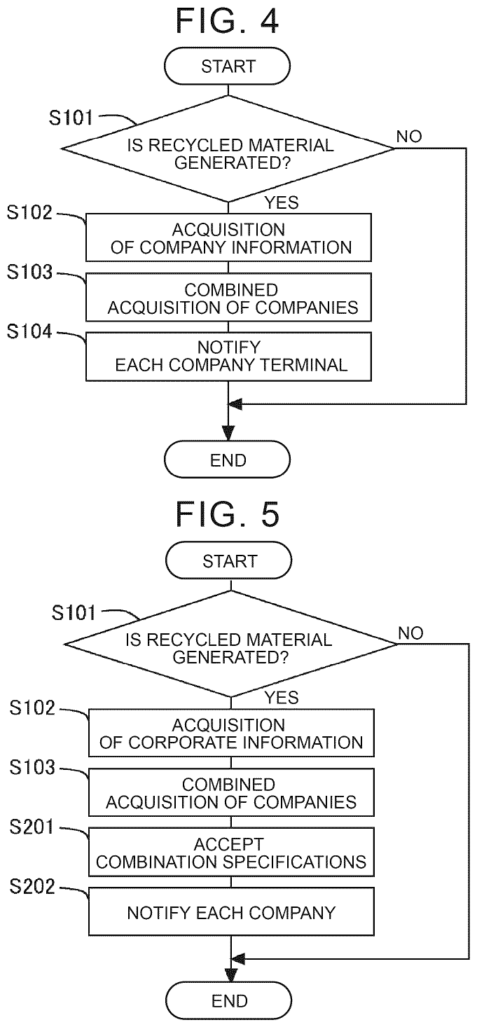

FIG. 4 is a flowchart illustrating a process executed in the server 30 according to the first embodiment. The flowchart illustrated in FIG. 4 is executed in the server 30 at predetermined time intervals. It is assumed that the required information is already stored in the company information DB321.

In S101, the control unit 31 determines whether or not a recycled material is generated. For example, when an automobile is disposed of, a recycled material is generated when the recycled material is disposed of in any process. For example, when the automobile is disposed of, the server 30 is notified of the occurrence of the recycled material from the terminal of the automobile dealer or the dismantling contractor. This notification includes information on the amount of recycled material and the location where it is generated. In addition, as another example, when a battery discarded overseas is imported, it is notified from the terminal of the importer to the server 30 that a recycled material has occurred. When the recycled material is generated as the waste material in each process, the server 30 is notified from the corresponding company terminal 20 that the recycled material is generated. If an affirmative determination is made in S101, the process proceeds to S102, and if a negative determination is made, the routine ends.

In S102, the control unit 31 acquires the company information. The company information may be read from the company information DB321, or may be requested to transmit company information to the company terminals 20. Next, in S103, the control unit 31 acquires the combination of the companies by inputting the information on the recycled material and the company information into the calculation model. Then, in S104, the control unit 31 notifies the company terminal 20 corresponding to the acquired combination of companies of the amount of the recycled material delivered and the delivery time.

As described above, according to the present embodiment, the control unit 31 determines the combination of companies that process the recycled material so that the load of each company becomes equal to or less than a predetermined load with respect to the processing of the recycled material. As a result, there is no bias in the load in each company, and thus it is possible to shorten the period required for recycling. In addition, since each company is notified of the amount of recycled material delivered and the delivery time, it becomes easier for each company to prepare a production plan. In this way, recycled materials can be appropriately allocated to companies involved in each process of recycling.

### Second Embodiment

In the second embodiment, when a plurality of combinations of enterprises are obtained, the user specifies which combination is to be determined. Therefore, the control unit 31 receives designation of a combination of enterprises from the user. Then, the amount of recycled material delivered and the delivery time are notified to the company terminal 20 corresponding to the combination of enterprises selected by the user. The user may be, for example, an operator of the server 30. The user designates a combination of enterprises via the input device 34.

FIG. 5 is a flowchart illustrating a process executed in the server 30 according to the second embodiment. The flowchart illustrated in FIG. 5 is executed in the server 30 at predetermined time intervals. It is assumed that the required information is already stored in the company information DB321. Steps in which the routine illustrated in FIG. 4 is executed by the same processing are denoted by the same reference numerals, and description thereof is omitted.

In the routine illustrated in FIG. 5, when the process of S103 is completed, S201 proceeds. In S201, the control unit 31 receives a designation of a combination of companies from the user. The control unit 31 causes the display 35 to display all of the combinations of companies acquired in S103, for example. Further, the control unit 31 may display, for example, a selection button on the display 35 so that the user can select any combination from among the displayed combinations of enterprises. The user selects a combination of enterprises by clicking on any selection button via the input device 34. In response to this click, the control unit 31 receives a selection of a combination of companies.

Then, in S202, the control unit 31 notifies the company terminal 20 corresponding to the combination of the enterprises received by S201 of the amount of the recycled material delivered and the delivery time.

In this way, it is also possible for the user to designate a combination of companies that deliver recycled materials among the combinations of companies acquired by the control unit 31. Thus, the delivery destination of the recycled material can be adjusted to some extent. For example, a particular enterprise may be prioritized, or an enterprise whose location is included in a particular region may be prioritized.

### Third Embodiment

In a third embodiment, CO₂ emissions and recycle rate are further considered when determining the mix of companies delivering recycled materials. The cost is, for example, the amount of money per unit mass when processing the recycled material. CO₂ emissions are CO₂ emissions per unit weight when recycled material is processed. The recycling rate is the ratio of recycled materials included in the company's products. The control unit 31 of the server 30 generates a combination of companies such that at least one of the cost, CO₂ emissions, and the recycle rate falls within a predetermined range. It should be noted that, for example, the lower the cost and CO₂ emissions or the higher the recycle rate in the respective enterprises, the higher the recycle rate may be selected in preference.

For example, Key Performance Indicator (KPI) and regulations may require that CO₂ emissions be less than or equal to a predetermined value before a final product (e.g., a battery) is completed using recycled material, or may require that the recycle rate be greater than or equal to a predetermined value. In such cases, the firm mix may be determined as a whole so that the cost, CO₂ emissions, or recycle rate meets the requirements set forth in KPI or legislation.

In this instance, information regarding each of the cost, CO₂ emissions, or recycle rate corresponding to each company is included in the company information, and is stored in the company information DB321. The computational model stored in the storage unit 32 is configured to output a combination of companies by further inputting a cost, a CO₂ emission amount, or a recycle rate.

In this way, an appropriate set of enterprises can be obtained even if the cost, CO₂ emissions, or recycle rate, is conditioned.

### OTHER EMBODIMENTS

The above embodiments are only examples, and the disclosure may be carried out with various modifications without departing from the essence thereof. The processes and means described in the present disclosure can be freely combined and implemented as long as no technical contradiction occurs. Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

What is claimed is:

1. An information processing device comprising a control unit configured to:
acquire respective past processing performances of a plurality of companies that constitutes a supply chain that manufactures a product through a plurality of processes using a recycled material, a current load state, an inventory amount, and an amount of the recycled material required;
in response to generation of the recycled material, generate a combination of companies corresponding to respective ones of the processes, loads on the companies corresponding to the respective processes being equal to or less than respective predetermined loads, according to the past processing performance, the current load state, the inventory amount, and the amount of the recycled material required; and
output information about a delivery time and a delivery amount of the recycled material to respective terminals of the companies corresponding to the generated combination of companies.

2. The information processing device according to claim 1, wherein the control unit is configured to:
in response to there being a plurality of combinations of companies, receive a combination of companies specified by a user, among the combinations of companies corresponding to the processes; and
output information about a delivery time and a delivery amount of the recycled material to respective terminals of the companies corresponding to the combination of companies specified by the user.

3. The information processing device according to claim 1, wherein the control unit generates a combination of companies using a model that receives a location of generation of the recycled material, an amount of the recycled material generated, the past processing performance, the current load state, the inventory amount, and the amount of the recycled material required as input data, and that outputs a combination of companies as output data.

4. The information processing device according to claim 1, wherein when generating a combination of companies, the control unit generates a combination of companies such that at least one of a cost, a carbon dioxide emission amount, and a recycle rate for manufacturing the product is within a predetermined range.
